(19) United States
(12) Patent Application Publication
(10) Pub. No.: US 2004/0243270 A1
(43) Pub. Date: Dec. 2, 2004

(54) Partial least squares based paper curl and twist modeling, prediction and control

(75) Inventor: Raja Amirthalingam, Columbus, OH (US)

Correspondence Address: Michael M. Rickin, Esq., ABB Inc., Legal Department - 4U6, 29801 Euclid Avenue, Wickliffe, OH, 44092-1832, US

(73) Assignee: ABB Inc.

(21) Appl. No.: 10/448,600

(22) Filed: May 30, 2003

(51) Int. Cl. G06F 17/10; G06F 7/66; G06F 7/60

(52) U.S. Cl. 700/128

(57) ABSTRACT

A method is described for using the partial least squares (PLS) technique for modeling, predicting and controlling curl and twist in a paper machine. The prediction variables to the model are selected quality control system measurements and paper machine variables. The selection is based on incremental error analysis of individual prediction variables and can be improved using score contribution analysis. The predicted variables to the model are the curl and twist measurements which are determined from the samples taken at the end of the reel. The PLS model is identified and used in an on-line framework and the model is continuously updated with new data as required. A control strategy to use the PLS model for controlling curl and twist is included. There is also described a method which uses as inputs to the model only the measurements from a fiber orientation sensor and the curl and twist measurements.

### FIELD OF THE INVENTION

This invention relates to the making of paper and paperboard and more particularly to the curl and twist that occur in the paper and paperboard.

### DESCRIPTION OF THE PRIOR ART

Curl and twist are undesired deformation characteristics of paper and paperboard often induced by humidity and temperature variations of the environment to which they are exposed. For ease of description “paper and paperboard” will be referred to hereinafter as “paper” but will be understood to mean unless the context indicates otherwise both paper and paperboard. Curl and twist in paper is one of the main reasons for reel rejection for which a suitable solution is still lacking among the paper industries.

Fiber orientation is a contributing factor for curl and twist in paper. Fiber orientation variables, namely, fiber orientation ratio and fiber orientation angle, are usually measured at the top and bottom side of the paper. When the lengthwise distribution of fibers in a 360° angle in the two dimensional surface of a paper is represented as an ellipse, the length of the major axis, length of the minor axis, and the axis that makes an acute angle with the axis of the machine direction (numerator axis) are used in calculating the fiber orientation ratio and fiber orientation angle. If the numerator axis is the major axis, the ratio of the major axis to the minor axis (>1) is the fiber orientation ratio and the acute angle is the fiber orientation angle. If the numerator axis is the minor axis, the ratio of the minor axis to the major axis (<1) is the fiber orientation ratio and the acute angle is the fiber orientation angle.

A wood fiber swells or contracts 20 times along its width compared to its length. Because of this, when the top fiber orientation ratio is greater than 1 and the bottom ratio is equal to 1, an increase or decrease in moisture causes a curl with its axis along the machine direction. Since an increase in moisture causes swelling and a decrease in moisture causes contraction, the result will be a downward curl during an increase in moisture and an upward curl during a decrease in moisture. This type of curl is commonly known as CD-Curl. When the top ratio is less than 1, the curl phenomena occur in a similar fashion with the curl axis being in a cross direction. This type of curl is known as MD-Curl.

Paper can also exhibit diagonal curl with its axis at an angle from the machine direction due to various reasons. One reason is that the fiber angle can be significantly different from “0”. Another reason could be due to the internal helical nature of the fibrils that constitutes the wood fibers. When the fiber swells or contracts due to moisture changes, the fibers may undergo twist along the longitudinal axis causing the paper to twist. Thus the observed curl in a paper can be MD Curl, CD Curl, or Twist, or a combination of these three. For ease of description hereinafter, “curl and twist” may be referred to hereinafter as “curl” but will be understood unless the context indicates otherwise to mean both curl and twist. The curl that is due to fiber orientation is also known as wet-end curl.

When the top and bottom ratios are equal to 1, that is, a square sheet, a curl in the finished paper can be simply due to differential drying restraints between the two directions (MD and CD) and the two sides (top and bottom). This type of Curl/Twist is known as dry-end curl. If the paper has been manufactured under restraint, either in the MD direction or CD direction, the resulting Curl/Twist due to a humidity/temperature change during end-use could be due to the superimposed effect of Curl/Twist induced by the humidity/temperature change and the inherent Curl/Twist that was waiting to be released by some head-start mechanism. The inherent Curl/Twist is said to be due to internal strain. Other parameters such as fiber thickness, fiber density, and individual ply characteristics in the case of a multi-ply board, coat weight, moisture distribution, etc. can also have an impact on curl and twist and those can be major contributors compared to fiber orientation depending on the situation.

The MD curl and CD curl coexisting in a typical paper sample is shown in FIG. 1(a). FIG. 1(b) shows the presence of only twist in a paper sample and FIG. 1(c) shows the superimposed effect of twist on a sample with MD and CD curl.

The driving force for the paper curl can be either internal, external, or both. The curl due to the non-homogeneity of the paper, for example, due to the fiber orientation difference between the machine direction (MD) and the cross direction (CD) is called internal curl. The curl due to the humidity or temperature differences to which the two sides of a paper are exposed, for example, due to the differential heating of the two sides in laser printing is called external curl.

The explanation of the curl phenomena due to non-homogeneity of the paper can be derived from the physical nature of the wood fibers and their behavior under moisture variations. Uneven swelling or contraction of wood fibers of different micro-layers of a paper parallel to its surface is the basic reason for curl. The non-homogeneity of a paper with respect to fiber distribution can be captured using a fiber orientation sensor which yields as is described above four measurement variables namely, top fiber orientation ratio, bottom orientation fiber ratio, top fiber orientation angle, bottom fiber orientation angle.

Although fiber orientation influences curl and twist to a great extent, numerous other variables in the paper machine may also have a significant effect on curl and twist during the production of paper. This then makes modeling and controlling curl and twist a complex control problem. Given the fact that curl and twist can be measured and captured as one or more parameter values, the problem in modeling and controlling curl and twist is to correlate the many input measurements including fiber orientation to these parameters. The objective of modeling is to predict curl and twist online and to implement automatic control techniques to address any deviations from the target requirement.

In an industrial setting, curl and twist are usually measured on a reel basis for quality assurance. This allows a reel to be either rejected or accepted according to the end purpose of the product and its property requirements. The standard curl and twist measurement procedure involves obtaining samples at the end of the reel and measuring the curl and twist tendencies by subjecting the samples to a change of humidity or temperature. The MD curl, CD curl, and the curl and twist as shown in FIG. 1 is usually referred to as Kₓ, K_{y}, and K_{xy}. Curl and twist cross directional profiles can also be obtained if many samples are taken from a cross directional strip cut out of the reel.

The independent variables for modeling curl and twist includes a set of machine parameters that changes very slowly with respect to time and a set of upstream measurements, which can be both slow and fast (Cross Directional-CD/Machine Directional-MD) with respect to time. Since curl and twist are typically reel based batch measurements, in order to apply static modeling techniques, the dynamic input variables are required to be averaged before modeling.

The present invention solves these problems by using the Partial Least Squares (PLS) technique in the manner described herein for modeling and controlling both curl and twist or twist alone depending on the quality control system (QCS) profile measurements used as inputs to the model. PLS is a general static modeling tool for relating input and output variables, which is very efficient and appropriate when not all the input variables influence the output variables. A general description of the use of PLS in modeling is given in Geladi, P. and B. R. Kowalski (1986): “Partial Least Squares: A Tutorial”, Anal. Chim. Acta, PP1-17. By identification, the PLS technique yields a model based on certain user specified parameters such as latent variables. To date there has been very little work in modeling, predicting and controlling curl and twist in a paper machine and thus in using PLS for that purpose. The present invention provides a framework for implementing the PLS technique for modeling, predicting and controlling curl and twist in a paper machine.

### SUMMARY OF THE INVENTION

A method for modeling, predicting and controlling curl and twist in a paper machine using the partial least squares (PLS) technique. The method:

selects based on PLS prediction error for each of a predetermined number of curl and twist parameters a set of paper machine quality control measurements and a set of paper machine operating variables as prediction variables for PLS modeling; and

identifies one or more PLS models based on the PLS modeling prediction variables and the curl and twist parameters.

A method for modeling and predicting curl and twist in a paper machines using the partial least squares (PLS) technique. The method identifies one or more PLS models based on measurements from a fiber orientation sensor and a predetermined number of curl and twist parameters.

Prediction variables for partial least squares (PLS) technique modeling for modeling, predicting and controlling curl and twist in a paper machine. The prediction variables include but are not limited to:

a set of paper machine quality control measurements and a set of paper machine operating variables both selected based on PLS prediction error for each of a predetermined number of curl and twist parameters;

the set of paper machine quality control measurements for one of the predetermined number of curl and twist parameters include but are not limited to:

fibreratio bottom side, fibreratio top side, moisture before Pope reel, moisture before bottom coater, webweight conditioned before Pope reel, thickness before Pope reel, thickness after calender, moisture after calender, fibreangle top side, brightness bottom side, gloss before Pope reel and webweight before Pope reel;

the set of paper machine operating variables for the one of the predetermined number of curl and twist parameters include but are not limited to:

plyratio HB2, softwood ratio bottomlayer, softwood ratio toplayer, hardwood ratio bottomlayer and speed fan pump HB 4.

### DESCRIPTION OF THE DRAWING

FIGS. 1(a), (b) and (c) respectively show the MD curl and MD twist coexisting in a paper sample, the presence of only twist in a sample, and the superimposed effect of twist on a sample with MD curl and CD curl.

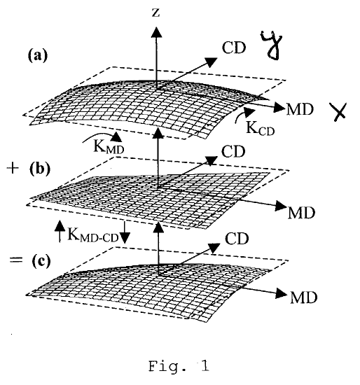

FIG. 2 shows a block diagram representation for the framework of using the PLS technique for modeling and predicting curl and twist in a paper machine.

FIG. 3 shows the prediction results for MD curl of the obtained model where the dotted line is the predicted results and the solid line is the actual results.

FIG. 4 shows the prediction results for CD curl of the obtained model where the dotted line is the predicted results and the solid line is the actual results.

FIG. 5 shows the prediction results for twist of the obtained model where the dotted line is the predicted results and the solid line is the actual results.

FIG. 6 shows a mapping of the manipulated variables and measurements for control.

FIGS. 7(a), (b) and (c) show the predicted and measured curl/twist profiles with the PLS model where the input variables are the four OF measurements with FIGS. 7(a) and 7(c) representing the validation data and FIG. 7(b) representing the modeled data.

### DESCRIPTION OF THE PREFERRED EMBODIMENT(s)

In accordance with the present invention, there is described herein with respect to a paper machine producing multi-ply paperboard, a framework for implementing the PLS technique for modeling, predicting and controlling curl and twist in the paper machine. While the framework is described herein with respect to a paper machine producing multi-ply paperboard, it should be appreciated that it is applicable to any paper machine.

The framework includes selection of key measurements during the modeling stage in order to eliminate unnecessary input measurements. Any unnecessary input measurements can only be detrimental in the output prediction when included in spite of the theoretical capabilities of the PLS modeling technique. Removing unnecessary measurements can make a significant beneficial impact on accuracy and performance of the overall framework.

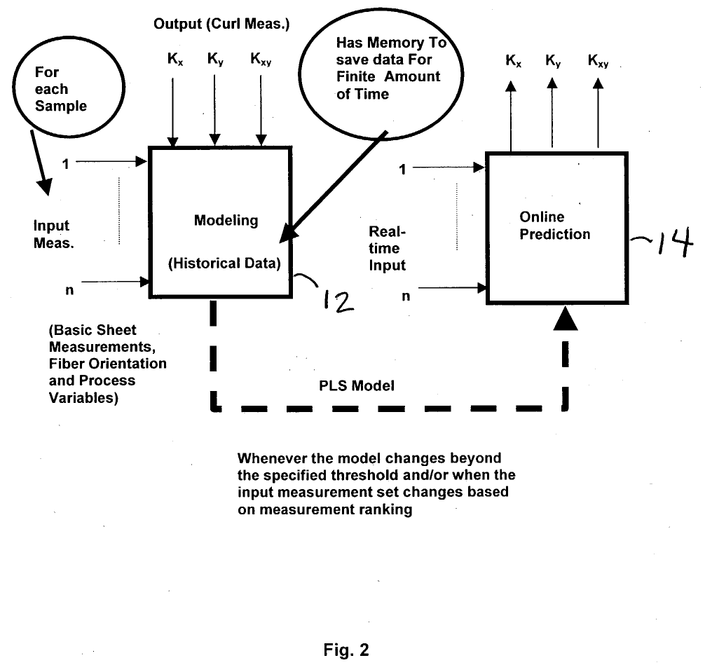

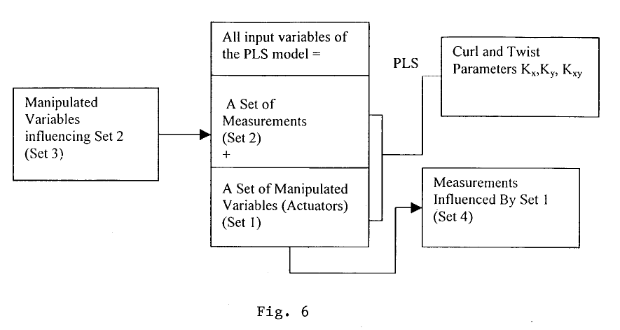

Referring now to FIG. 2, there is shown a block diagram representation of the framework 10 of the present invention that uses the PLS technique for modeling and prediction of curl and twist in a paper machine. The framework for using the prediction model for control is described below in combination with the description of FIG. 6.

The n inputs to the model 12 (prediction variables) are for each reel of paper produced by the paper machine. These n inputs are divided into two groups.

One group is the 19 high frequency quality control system (QCS) profile measurements from the one or more scanner(s) that scans across the paper web in the CD when the paper machine is operational. These QCS profile measurement inputs are listed in Table 1 and are obtained from sensors well known to those in the paper making art that are carried on the one or more scanners. The other group is the 29 paper machine variables or parameters listed in Table 2. Thus the 19 QSC profile measurements and the 29 paper machine variables combine to give 48 total input variables. The curl and twist measurements Kx, Ky and Kxy (predicted variables of online prediction 14) which are determined from samples taken at the end of the reel are also inputs to model 12.

TABLE 1

| | |
|---|---|
| 1 | Moisture before Pope Reel |
| 2 | Moisture before Bottom Coater |
| 3 | Webweight (conditioned) before Pope Reel |
| 4 | Thickness before Pope Reel |
| 5 | Thickness after calender |
| 6 | Moisture after calender |
| 7 | Webweight (conditioned) |
| 8 | Fibreangle bottom side |
| 9 | Fibreratio bottom side |
| 10 | Fibreangle top side |
| 11 | Fiberratio top side |
| 12 | Formation |
| 13 | Brightness bottom side |
| 14 | Gloss before Pope |
| 15 | Bottom Coating (weight) |
| 16 | Top Coating (weight) |
| 17 | Total Coating |
| 18 | Webweight before Pope Reel |
| 19 | Ashcontent |

TABLE 2

| | |
|---|---|
| 1 | Production before coating |
| 2 | Plyratio HB 1 |
| 3 | Plyratio HB 2 |
| 4 | Plyratio HB 3 |
| 5 | Plyratio HB 4 |
| 6 | Jet/Wireratio HB 1 |
| 7 | Jet/Wireratlo HB 2 |
| 8 | Jet/Wireratio HB 3 |
| 9 | Jet/Wireratio HB 4 |
| 10 | Softwoodratio Bottomlayer |
| 11 | Softwoodratio Centerlayer |
| 12 | Softwoodratio Toplayer |
| 13 | Hardwoodratio Bottomlayer |
| 14 | Hardwoodratio Centerlayer |
| 15 | Hardwoodratio Toplayer |
| 16 | Brokeratio Centerlayer |
| 17 | Speed Fanpump HB 1 |
| 18 | Speed Fanpump HB 2 |
| 19 | Speed Fanpump HB 3 |
| 20 | Speed Fanpump HB 4 |
| 21 | Wirespeed |
| 22 | Diff. Pressure HB 1 |
| 23 | Diff. Pressure HB 2 |
| 24 | Diff. Pressure HB 3 |
| 25 | Diff. Pressure HB 4 |
| 26 | Recirc. valve HB 1 |
| 27 | Recirc. valve HB 2 |
| 28 | Recirc. valve HB 3 |
| 29 | Recirc. valve HB 4 |

It has been found that using all 48 of the input variables as the input measurements 1 to n shown in FIG. 2 to the model 12 and the three curl parameters without using knowledge of the process, that is, papermaking, does not provide good model. It has also been found that fiber orientation measurements contribute to the model for curl and twist at a higher percentage compared to other measurements. It has further been found that while, as is described herein, fiber orientation measurements alone may give rise to a model for curl and twist, a better model can be obtained using measurements in addition to fiber orientation measurements. As a result of the two separate findings, it has also been further found that it is necessary to identify QCS profile measurements other than the fiber orientation measurements that influence the curl and twist. Also, a subset of machine operational variables influencing the curl and twist needs to be identified.

The raw historical data available for the modeling, predicting and controlling framework described herein includes curl and twist measurements for each reel produced, high frequency QCS profile measurements from the scanner (see Table 1), and machine parameters (see Table 2)for each reel. The high frequency QCS profile measurements were first averaged to yield a single measurement for each reel. Curl and twist measurements available at more than one location in the cross direction were also averaged to obtain a single set of Kₓ, K_{y}, and K_{xy} measurements for each reel.

The steps described below were followed to obtain the effective inputs for predicting Kₓ, K_{y}, and K_{xy}. These steps can be implemented in a software environment where PLS algorithms are available.

With Kₓ as the output, that is, predicted variable of online prediction 14, these steps are:

1. Apply PLS with inputs being Fibreratio bottom side and Fibreratio top side and outputs being Kₓ alone.

a. It was found that modeling all three parameters, Kₓ, K_{y}, K_{xy}, together as outputs did not provide a good model.

2. Add one input at a time and then compare the PLS prediction error as the basis for accepting or rejecting each added input.

b. A reduction in prediction error should be proceeded with accepting the new input.

3. With the final set of input variables, the above method was reconciled by testing prediction error with addition of each rejected variable and also by testing prediction error with removal of each accepted variable.

4. The final set of inputs was obtained and are shown in Table 3 below where (M) is a machine variable and (QCS) is a QCS measurement.

TABLE 3

| | | |
|---|---|---|
| 9 (QCS) | 1 | Fibreratio bottom side |
| 11 (QCS) | 2 | Fiberratio top side |
| 1 (QCS) | 3 | Moisture before Pope |
| 2 (QCS) | 4 | Moisture before Bottom Coater |
| 3 (QCS) | 5 | Webweight (conditioned) before Pope |
| 4 (QCS) | 6 | Thickness before Pope |
| 5 (QCS) | 7 | Thickness after calender |
| 6 (QCS) | 8 | Moisture after calender |
| 10 (QCS) | 9 | Fibreangle top side |
| 13 (QCS) | 10 | Brightness bottom side |
| 14 (QCS) | 11 | Gloss before Pope |
| 18 (QCS) | 12 | Webweight before Pope |
| 3 (M) | 13 | Plyratio HB 2 |
| 10 (M) | 14 | Softwoodratio Bottomlayer |
| 12 (M) | 15 | Softwoodratio Toplayer |
| 13 (M) | 16 | Hardwoodratio Bottomlayer |
| 20 (M) | 17 | Speed Fanpump HB 4 |

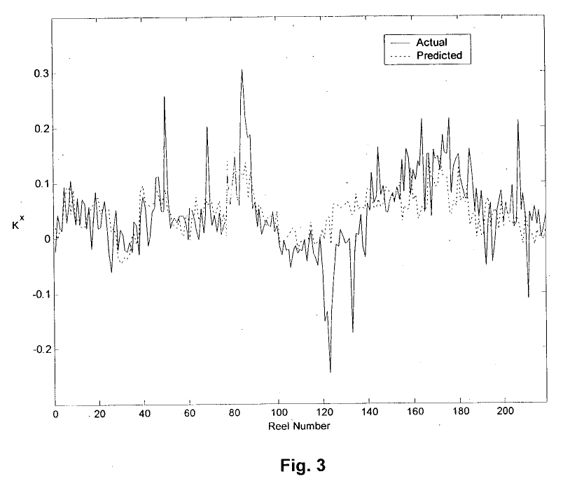

The prediction results of the obtained model are shown in FIG. 3 where the dotted line is the predicted results and the solid line is the actual results.

The steps described above with Kₓ as the output variable were repeated with K_{y} as the output variable and the resulting input list is shown below in Table 4 with (M) as the machine variable and (QCS) as the QCS measurement.

TABLE 4

| | | |
|---|---|---|
| 9 (QCS) | 1 | Fibreratio bottom side |
| 11 (QCS) | 2 | Fiberratio top side |
| 1 (QCS) | 3 | Moisture before Pope Reel |
| 2 (QCS) | 4 | Moisture before Bottom Coater |
| 3 (QCS) | 5 | Webweight (conditioned) before Pope |
| | | Reel |
| 5 (QCS) | 6 | Thickness after calender |
| 6 (QCS) | 7 | Moisture after calender |
| 8 (QCS) | 8 | Fibreangle bottom side |
| 10 (QCS) | 9 | Fibreangle top side |
| 12 (QCS) | 10 | Formation before calendar |
| 13 (QCS) | 11 | Brightness bottom side |
| 14 (QCS) | 12 | Gloss before Pope Reel |
| 15 (QCS) | 13 | Bottom Coating (weight) |
| 18 (QCS) | 14 | Webweight before Pope Reel |

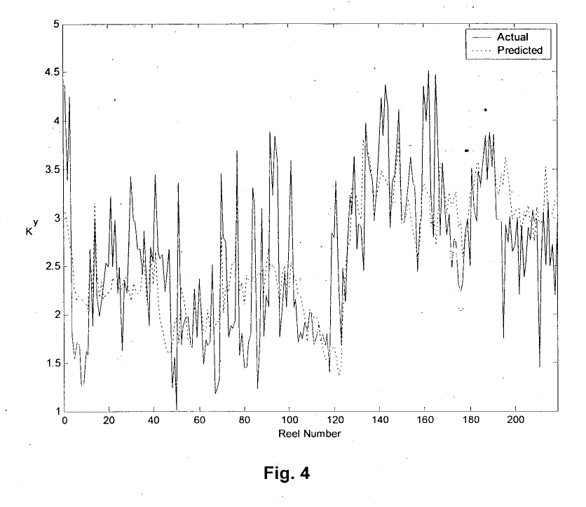

The prediction results of the obtained model are shown in FIG. 4 where the dotted line is the predicted results and the solid line is the actual results.

These same steps were repeated with K_{xy} as the output variable and the resulting input list is shown below in Table 5 with (M) as the machine variable and (QCS) as the QCS measurement.

TABLE 5

| | | |
|---|---|---|
| 9 (QCS) | 1 | Fibreratio bottom side |
| 11 (QCS) | 2 | Fiberratio top side |
| 1 (QCS) | 3 | Moisture before Pope Reel |
| 4 (QCS) | 4 | Thickness before Pope Reel |
| 5 (QCS) | 5 | Thickness after calender |
| 6 (QCS) | 6 | Moisture after calender |
| 10 (QCS) | 7 | Fibreangle top side |
| 14 (QCS) | 8 | Gloss before Pope Reel |
| 16 (QCS) | 9 | Top coating (weight) |
| 4 (M) | 10 | Plyratio HB 3 |
| 6 (M) | 11 | Jet/Wireratio HB 1 |
| 9 (M) | 12 | Jet/Wireratio HB 4 |
| 10 (M) | 13 | Softwoodratio Bottomlayer |
| 14 (M) | 14 | Hardwoodratio Centerlayer |
| 15 (M) | 15 | Hardwoodratio Toplayer |
| 18 (M) | 16 | Speed Fanpump HB 2 |

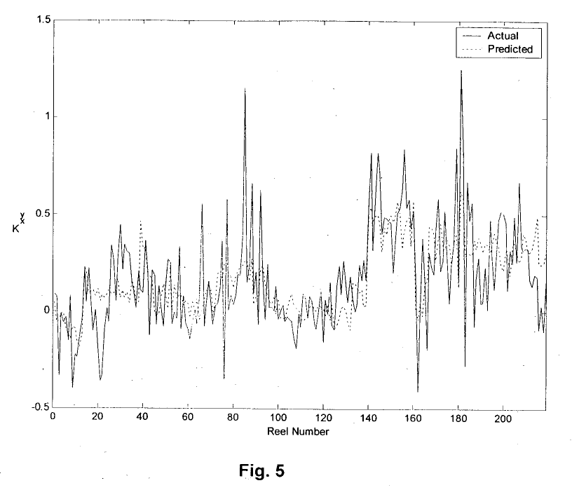

The prediction results of the obtained model are shown in FIG. 5 where the dotted line is the predicted results and the solid line is the actual results.

Another commonly known input ranking technique called score contribution analysis was also found useful for improved ranking of the inputs to the model. However, score contribution analysis with the historical data was not effective with that data. A reasonably good prediction model from the PLS identification is required in order to have any beneficial results from using score contribution analysis of the inputs to the model.

Mainly due to this reason, score contribution analysis cannot be applied to eliminate unwanted measurements in the preliminary modeling stage using historical analysis. This technique needs to be applied when data with better operating conditions during a closely observed production process is obtained.

The results from PLS modeling of a set of input(U matrix) and output data (Y matrix) are input loading matrix(P), output loading matrix(Q), input weights matrix(W), inputs scores matrix(T), outputs scores matrix(S), inner relation matrix(B).

In using score contribution analysis the individual input components in the scores obtained are used as described below.

For a PLS model with number of latent variables=n₁ᵥ, number of observations=nₙ and number of inputs nᵤ, if the input weights are represented by W matrix (nₙ×n₁ᵥ) and inputs are represented by U matrix (nₙ×nᵤ), then the contribution of each input in the first score can be obtained as follows, C(i,j,1)=U(i,j)*W(j,1) where j is the input indeed and i is the observation index. S(j)=Sum(C(i,j), for i=1 to nᵤ) is the first score where by the residual U(i,j)=U(i,j)−S(j)*P(:,j)′ is used in the similar manner to calculate the contribution C(i,j) for the second score using C(i,j,2)=U(i,j)*W(j,2). This is repeated for all i's and j's which results in a C matrix of size nₙ×nᵤ×n₁ᵥ. When this matrix is averaged for each input, it gives the cumulative contribution of each input for all the observations and all the latent variables. While averaging along the dimension of the latent variables, it is also weighted based on what percentage of variations in the outputs are represented by each of the latent variables. Based on overall contribution, all input variables are ranked with rank. “1” being the most important variable for PLS modeling.

A PLS model can be obtained once the measurements/machine variables that highly influence the curl and twist parameters are known by the above described ranking technique, that is, the steps followed for obtaining the effective inputs for predicting Kₓ, K_{y}, and K_{xy}. A PLS model with more input variables than output variables cannot be easily used in control by model inversion as there is no one to one correspondence between inputs and outputs. In addition, the input variables in the case of the present modeling framework include measurements for which appropriate manipulated variables have to be determined.

Among the input (prediction) variables list finally chosen for the PLS modeling based on the ranking procedure(see FIG. 6), there are manipulated variables (Set 1 of FIG. 6) and measurements (Set 2 of FIG. 6). There may be manipulated variables (Set 3 of FIG. 6) outside this list that influence these measurements (Set 4 of FIG. 6) and there may be other measurements outside this list that are influenced by these manipulated variables. The first and foremost requirement for control is to map them all as shown in FIG. 6.

Once Set 3 and Set 4 are known, the multivariable dynamic model is determined between combined manipulated variables Set 1 and Set 3 and the measurements Set 2 and Set 4. The static relationship between Set 1 and Set 2 is a limiting factor in determining the required change in Set 1 and Set 2 to obtain the desired change in Kₓ,K_{y}, K_{xy} at any instant. However, subjected to this limitation, it is always possible to obtain a change required in the variables of Set 1 and Set 2 for the required changes in Kₓ, K_{y}, K_{xy}. Since changes in Set 1 are subjected to the limitations on Set 4, the changes in Set 1 are calculated carefully without violating the limits on Set 4. The remaining change in Set 2 to obtain the target change in Kₓ, K_{y}, K_{xy} can be implemented by calculating the change required in Set 3 using a dynamic model between Set 3 and Set 2 with any multivariable control technique such as Model Predictive Control by considering Set 1 as feed forward inputs. Information about Model Predictive Control can be found in K. R. Muske and J. B. Rawlings. Model Predictive Control with Linear Models. AIChE Journal, 39(2):262-287, 1993,; M. Morari, and J. H. Lee, Model Predictive Control: The good, the bad, and the ugly in Y. Arkun and W. H. Ray (eds.) Chemical Process Control—CPC IV, Fourth International Conference on Chemical Process Control, Elsevier, Amsterdam, 1991.

The present invention has been described herein in connection with an embodiment that uses measurements in addition to those from a fiber orientation (OF) sensor. Described below is a further embodiment for the present invention which uses measurements only from a OF sensor. The samples used in this embodiment were obtained from a paper mill in the form of CD strips and corresponding online OF measurements were provided with respective time stamps.

A single point OF measurement at any location of a paper at any instant includes the top fiber ratio (or back side fiber ratio), bottom fiber ratio (or print side fiber ratio), top angle, and bottom angle. Since the OF sensor is mounted on a scanner, the OF measurements available in this embodiment includes both CD and MD. In MD, the measurements were available at the scanning speed and in the CD, the measurements were available for 600 data boxes. The OF measurements were averaged along the MD and among the measurement data boxes corresponding to each sample cut from the CD strip. The MD measurements of OF were mainly used for obtaining a representative average at any particular CD location for each reel. Similarly, when multiple CD strips were available for curl/twist measurement from the same reel, curl parameters were also averaged for the same CD positions.

Sample preparation and conditioning is essential. It is noted that curl is not an absolute physical property, but a relative deformation parameter, which can be obtained by disturbing its equilibrium with humidity and temperature changes. By fixing the conditioning procedure, different samples with varying curl tendency can be compared and related. Since the objective is to capture the relationship between the curl/twist parameters and OF measurements, fixing a conditioning procedure will not affect the results as long as the conditioning is handled carefully and uniformly for all samples.

The samples used herein were moisten in a chamber which is controlled to 98% relative humidity with a CuSO₄ solution to a moisture content of ˜15%. Samples of size 7″×7″ were cut from the CD strips in order to measure the MD-curl, CD-curl, and twist. The room temperature was maintained at 24° C. and the room relative humidity was at 65% at which the all the samples were flat.

For a separate set of samples, drying tests were also conducted and the curl tendency was compared with wetting. The relative curl/twist tendency among the CD samples were found to be similar, but, in the opposite directions. However, due to a limited availability of samples, a majority of the samples were only subjected to wetting condition as described above and used herein.

Samples were grouped according to the jet-to-wire speed difference (Δv_{jw}) of the paper machine into three sets. The final data consisted of four OF measurements and three curl measurements of 23 CD points for three different Δv_{jw} settings. The three Δv_{jw} settings of the samples are shown below in Table 6.

TABLE 6

| | Top Ply | Bottom Ply |
|---|---|---|
| | Δ v_{jw} Speed | Δ v_{jw} Speed |
| | difference | difference |
| | (m/min) | (m/min) |
| Sample | −12 | 1.3 |
| Set - a | | |
| Sample | −12 | 4 |
| Set - b | | |
| Sample | −20 | 1.3 |
| Set - c | | |

Since there were four OF measurements (inputs) and three curl/twist measurements (outputs), the objective in PLS modeling was to capture the multivariate relationship between them with a minimum number of model parameters (latent variables). To make modeling and validation meaningful, only one set of data (data from a single Δv_{jw} setting) was used for modeling and evaluated the prediction capability using the remaining set of samples. The number of latent variables used in modeling was three (3).

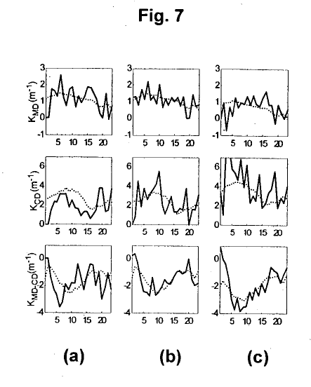

FIG. 7 shows the predicted and measured curl/twist profiles with the PLS model where the input variables are the four representative OF measurements for each 7″×7″ sample taken from the CD strip: top fiber ratio, bottom fiber ratio, top angle, and bottom angle. The plots shown in FIG. 7(b) represent the modeled data and the plots shown in FIGS. 7(a) and 7(c) represent the validation data. The correlation between the measured and predicted curl parameters such as MD curl (K_{MD}), CD curl (K_{CD}), and twist (K_{MD-CD}) for each profile is given in Table 7. The mean squared errors between the actual and predicted curl parameters are also provided in Table 8.

TABLE 7

| | | Modeled | |
|---|---|---|---|
| Curl | Validation | Data | Validation |
| Parameters | Data Set -1 | Set | Data Set -2 |
| K_{MD} (m⁻¹) | 0.46 | 0.80 | 0.12 |
| K_{CD} (m⁻¹) | 0.31 | 0.72 | 0.74 |
| K_{MD-CD} (m⁻¹) | 0.54 | 0.87 | 0.73 |

TABLE 8

| Curl | Validation | Modeled | Validation |
|---|---|---|---|
| Parameters | Data Set -1 | Data Set | Data Set -2 |
| K_{MD} (m⁻¹) | 0.21 | 0.04 | 0.34 |
| K_{CD} (m⁻¹) | 1.66 | 0.49 | 3.30 |
| K_{MD-CD} (m⁻¹) | 0.46 | 0.11 | 0.54 |

The above results from PLS model prediction show that with OF alone, prediction of twist is reasonable. However, MD-curl and CD-curl prediction is not satisfactory to the level that the model can be used for online monitoring and control.

It is to be understood that the description of the preferred embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A method for modeling, predicting and controlling curl and twist in a paper machine using the partial least squares (PLS) technique comprising:
a. selecting based on PLS prediction error for each of a predetermined number of curl and twist parameters a set of paper machine quality control measurements and a set of paper machine operating variables as prediction variables for PLS modeling; and
b. identifying one or more PLS models based on said PLS modeling prediction variables and said curl and twist parameters.

2. The method of claim 1 further comprising:
separating said paper machine operating variables into a first set of manipulated variables and a first set of measured variables;
combining said first set of measured variables and said paper machine quality control measurements;
determining a second set of manipulated variables apart from said first set of manipulated variables that influence said combined measurements; and
determining a second set of measured variables apart from said combined measurements that are influenced by said first set of manipulated variables.

3. The method of claim 2 further comprising:
identifying a dynamic model between said second set of manipulated variables and said combined measurements; and
designing a model based control strategy for said combined measurements using said second set of manipulated variables while treating said first set of manipulated variables as feed forward inputs.

4. The method of claim 3 further comprising:
determining deviations from a target of said curl and twist parameters and a set of the change required for said prediction variables of said one or more PLS models to drive said deviations to zero;
separating said change required for said prediction variables into change required for said combined measurements and change required for said first set of manipulated variables; and
implementing said model based control strategy for said change required for said combined measurements by including said change required for said first set of manipulated variables as a feed forward input and by constraining the influence of said first set of manipulated variables on said second set of measured variables.

5. The method of claim 1 further comprising using score contribution analysis to eliminate one or more of said selected prediction variables before identifying one or more PLS models.

6. A method for modeling and predicting curl and twist in a paper machine using the partial least squares (PLS) technique comprising:
identifying one or more PLS models based on measurements from a fiber orientation sensor and a predetermined number of curl and twist parameters.

7. The method of claim 6 further comprising:
identifying a dynamic model between the jet to wire speed difference and said fiber orientation sensor measurements; and
designing a model based control strategy for said fiber orientation sensor measurements using said jet to wire speed difference as the manipulated variable.

8. The method of claim 7 further comprising:
determining deviations from a target of said curl and twist parameters and a set of the change required for said fiber orientation sensor measurements to drive said deviations to zero;
identifying the dominant and desired measurement among said fiber orientation sensor measurements and the required change for said dominant and desired measurement; and
implementing said model based control strategy for said change required for said dominant and desired measurement using said jet to wire speed difference as the manipulated variable.

9. Prediction variables for partial least squares (PLS) technique modeling for modeling, predicting and controlling curl and twist in a paper machine comprising:
a set of paper machine quality control measurements and a set of paper machine operating variables both selected based on PLS prediction error for each of a predetermined number of curl and twist parameters;
said set of paper machine quality control measurements for one of said predetermined number of curl and twist parameters comprising:
fibreratio bottom side, fibreratio top side, moisture before Pope reel, moisture before bottom coater, webweight conditioned before Pope reel, thickness before Pope reel, thickness after calender, moisture after calender, fibreangle top side, brightness bottom side, gloss before Pope reel and webweight before Pope reel;
said set of paper machine operating variables for said one of said predetermined number of curl and twist parameters comprising:
plyratio HB2, softwood ratio bottomlayer, softwood ratio toplayer, hardwood ratio bottomlayer and speed fan pump HB 4.

10. The prediction variables of claim 9 wherein said prediction variables for another one of said predetermined number of curl and twist parameters is a set of paper machine quality control measurements comprising:
fibreratio bottom side, fibreratio top side, moisture before Pope reel, moisture before bottom coater, webweight conditioned before Pope reel, thickness after calender, moisture after calender, fibreangle bottom side, fibreangle top side, formation before calender, brightness bottom side, gloss before Pope reel, bottom coating (weight), and webweight before Pope reel.

11. The prediction variables of claim 9 wherein said set of paper machine quality control measurements for yet another one of said predetermined number of curl and twist parameters comprises:
fibreratio bottom side, fibreratio top side, moisture before Pope reel, thickness before Pope reel, thickness after calender, moisture after calender, fibreangle top side, gloss before Pope reel and top coating (weight); and
said set of paper machine operating variables for said yet another one of said predetermined number of curl and twist parameters comprises:
plyratio HB3, Jet/wireratio HB1, Jet/wireratio HB4, softwood ratio bottomlayer, hardwood ratio centerlayer, hardwood ratio toplayer and speed fan pump HB 2.
